(19) United States
(12) Patent Application Publication
(10) Pub. No.: US 2011/0162380 A1
(43) Pub. Date: Jul. 7, 2011

(54) METHOD TO INCREASE NET PLANT OUTPUT OF A DERATED IGCC PLANT

(75) Inventors: Pradeep S. Thacker, Houston, TX (US); Anindra Mazumdar, Houston, TX (US)

(73) Assignee: General Electric Company, Schenectady, NY (US)

(21) Appl. No.: 12/652,026

(22) Filed: Jan. 4, 2010

(51) Int. Cl. F02C 3/28; F02C 6/00; F02C 7/00; F01K 23/10

(52) U.S. Cl. 60/780; 60/784; 60/39.182; 60/39.5; 60/39.15

(57) ABSTRACT

In certain embodiments, a carbon capture integrated gasification combined cycle (IGCC) system includes a supplemental gas turbine engine configured to burn a high-hydrogen syngas to generate power only for an auxiliary load.

### BACKGROUND OF THE INVENTION

The subject matter disclosed herein relates to integrated gasification combined cycle (IGCC) power plants. More specifically, the disclosed embodiments relate to systems and methods for improving the performance of derated IGCC power plants.

IGCC power plants are capable of generating energy from various carbonaceous feedstock, such as coal or natural gas, relatively cleanly and efficiently. IGCC technology may convert the carbonaceous feedstock into a gas mixture of carbon monoxide (CO) and hydrogen (H₂), i.e., syngas, by reaction with oxygen and steam in a gasifier. These gases may be cleaned, processed, and utilized as fuel in the IGCC power plant. For example, the syngas may be fed into a combustor of a gas turbine of the IGCC power plant and ignited to power the gas turbine for use in the generation of electricity. However, IGCC power plants that utilize carbon capture techniques and IGCC power plants at high-elevation locations may experience a certain degree of derating, leading to lower net output.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes an integrated gasification combined cycle (IGCC) system. The IGCC system includes a gasifier configured to convert a feedstock into syngas. The IGCC system also includes a syngas cleaning system configured to scrub the syngas to create scrubbed syngas. The IGCC system further includes a carbon capture system configured to remove carbonous gases from the scrubbed syngas to create high-hydrogen syngas. In addition, the IGCC system includes a main gas turbine engine configured to burn the high-hydrogen syngas to generate power for a first primary load of the IGCC system. Further, the IGCC system includes a heat recovery steam generation (HRSG) system configured to receive heated exhaust gas from the main gas turbine engine and to generate steam using the heated exhaust gas as a source of heat. The IGCC system also includes a steam turbine engine configured to receive the steam from the HRSG system and to use the steam to generate power for a second primary load of the IGCC system. The system also includes a supplemental gas turbine engine configured to burn the high-hydrogen syngas to generate power for an auxiliary load of the IGCC system.

In a second embodiment, a carbon capture integrated gasification combined cycle (IGCC) system includes a supplemental gas turbine engine configured to burn a high-hydrogen syngas to generate power only for an auxiliary load.

In a third embodiment, a system includes a carbon capture gasification combined cycle (IGCC) system having a main gas turbine engine configured to generate power for a primary load and a supplemental gas turbine engine configured to generate power only for an auxiliary load. The system also includes a gas turbine engine controller configured to vary operating parameters of the main gas turbine engine and the supplemental gas turbine engine.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of an integrated gasification combined cycle (IGCC) power plant;

FIG. 2 is a schematic block diagram of an embodiment of two IGCC systems and a supplemental gas turbine engine configured to drive a compressor of a carbon capture system of the IGCC power plant of FIG. 1;

FIG. 3 is a schematic block diagram of an embodiment of two IGCC systems and the supplemental gas turbine engine of FIG. 2, wherein the supplemental gas turbine engine is configured to drive a generator, and the generator is configured to drive the compressor of the carbon capture system of FIG. 2;

FIG. 4 is a schematic block diagram of an embodiment of two IGCC systems and the supplemental gas turbine engine of FIG. 2, wherein the supplemental gas turbine engine is configured to drive the generator of FIG. 3, and the generator is configured to drive refrigeration systems of an acid gas removal (AGR) process of a syngas cleaning system of the IGCC power plant of FIG. 1; and

FIG. 5 is a schematic block diagram of an embodiment of two IGCC systems and the supplemental gas turbine engine of FIG. 2, wherein the supplemental gas turbine engine is configured to drive the generator of FIG. 3, and the generator is configured to drive air separation unit (ASU) compressors of the IGCC power plant of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to techniques and systems for improving net output of IGCC plants. More specifically, the disclosed embodiments are directed to techniques and systems for supplementing the power output of main gas turbine engines of IGCC plants, which have been derated by using high-hydrogen synthetic gases and/or by being located in high-elevation locations. For example, IGCC plants using carbon capture techniques may generate synthetic gases with higher hydrogen percentages than IGCC plants that do not use carbon capture techniques. This is due, at least in part, to the fact that carbon capture techniques remove large percentages of carbonous gases (e.g., carbon dioxide) from the synthetic gases generated by a gasification process of the IGCC plant. As such, the synthetic gases used by gas turbine engines of carbon capture IGCC plants have higher percentages of hydrogen than other combined cycle plants. This can lead to changes in firing temperatures of the gas turbine engines, thereby reducing the efficiency of the gas turbine engines. Similar deration may occur when the IGCC plants are located at higher elevations, because air used by the gas turbine engines may contain lower percentages of oxygen, again changing firing temperatures of the gas turbine engines.

The disclosed embodiments address deration of the main gas turbine engines of IGCC plants by using a supplemental gas turbine engine to supplement the power output of the main gas turbine engines. In particular, the supplemental gas turbine engine may drive specific auxiliary loads of the IGCC plants. For example, in certain embodiments, the supplemental gas turbine engine may be configured to drive a compressor of a carbon capture system of the IGCC plant. In addition, in other embodiments, the supplemental gas turbine engine may be configured to drive a supplemental electrical generator, which may be used to power various auxiliary loads throughout the IGCC plant. For example, in certain embodiments, the supplemental electrical generator may be used to drive the compressor of the carbon capture system mentioned above. In addition, in other embodiments, the supplemental electrical generator may be used to drive refrigeration systems of acid gas recovery (AGR) processes of the IGCC plant. Furthermore, in yet other embodiments, the supplemental electrical generator may be used to drive air separation unit (ASU) compressors of the IGCC plant. In addition, in certain embodiments, the supplemental electrical generator may be used to drive any combinations of these or other auxiliary loads of the IGCC plant.

In certain embodiments, the supplemental gas turbine engine and supplemental electrical generator may be dedicated to only driving auxiliary loads of the IGCC plant, rather than main loads of the IGCC plant. In other words, the supplemental gas turbine engine and supplemental electrical generator may only support other processes of the IGCC plant, rather than generating electricity for an external power grid. However, in other embodiments, the supplemental gas turbine engine and supplemental electrical generator may be used to make up for the loss of power of the main gas turbine engines of the IGCC plant to maintain a desired range of total power output of the IGCC plant.

In addition, in certain embodiments, the supplemental gas turbine engine may be associated with a controller, which may be used to vary operating parameters of the supplemental gas turbine engine, as well as the main gas turbine engines of the IGCC plant. For example, the controller may be configured to vary operating parameters of the supplemental gas turbine engine and the main gas turbine engines based on varying loads that use power from the supplemental gas turbine engine and the main gas turbine engines.

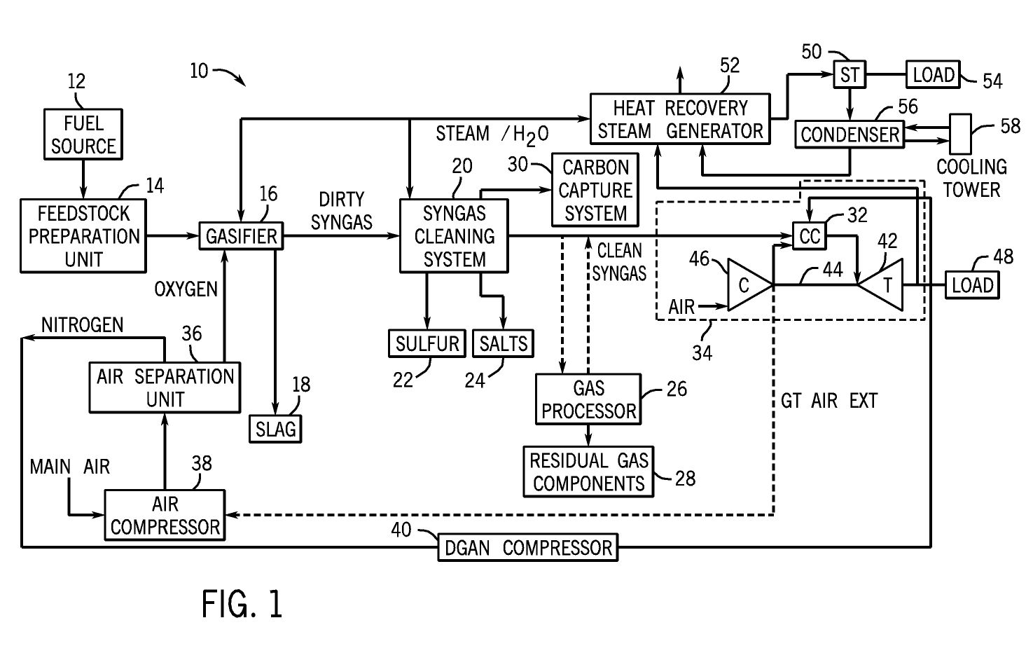

FIG. 1 illustrates an IGCC plant 10 that may be powered by synthetic gas, e.g., syngas. Elements of the IGCC plant 10 may include a fuel source 12, such as a solid feed, which may be utilized as a source of energy for the IGCC. The fuel source 12 may include coal, petroleum coke, biomass, wood-based materials, agricultural wastes, tars, coke oven gas and asphalt, or other carbon containing items. The solid fuel of the fuel source 12 may be passed to a feedstock preparation unit 14. The feedstock preparation unit 14 may, for example, resize or reshaped the fuel source 12 by chopping, milling, shredding, pulverizing, briquetting, or palletizing the fuel source 12 to generate feedstock. Additionally, water, or other suitable liquids, may be added to the fuel source 12 in the feedstock preparation unit 14 to create slurry feedstock. In other embodiments, no liquid is added to the fuel source 12, thus yielding dry feedstock.

The feedstock may be passed to a gasifier 16 from the feedstock preparation unit 14. The gasifier 16 may convert the feedstock into a combination of carbon monoxide and hydrogen, e.g., syngas. This conversion may be accomplished by subjecting the feedstock to a controlled amount of steam and oxygen at elevated pressures (e.g. from approximately 290 psia to 1230 psia) and temperatures (e.g., approximately 1300° F.-2900° F.), depending on the type of gasifier 16 utilized. The gasification process may include the feedstock undergoing a pyrolysis process, whereby the feedstock is heated. Temperatures inside the gasifier 16 may range from approximately 300° F. to 1300° F. during the pyrolysis process, depending on the fuel source 12 utilized to generate the feedstock. The heating of the feedstock during the pyrolysis process may generate a solid, e.g., char, and residue gases, e.g., carbon monoxide, and hydrogen.

A combustion process may then occur in the gasifier 16. The combustion may include introducing oxygen to the char and residue gases. The char and residue gases may react with the oxygen to form carbon dioxide and carbon monoxide, which provides heat for the subsequent gasification reactions. The temperatures during the combustion process may range from approximately 1300° F. to 2900° F. Next, steam may be introduced into the gasifier 16 during a gasification step. The char may react with the carbon dioxide and steam to produce carbon monoxide and hydrogen at temperatures ranging from approximately 1500° F. to 2000° F. In essence, the gasifier utilizes steam and oxygen to allow some of the feedstock to be “burned” to produce carbon monoxide and energy, which drives a second reaction that converts further feedstock to hydrogen and additional carbon dioxide. In this way, a resultant gas is manufactured by the gasifier 16. This resultant gas may include approximately 85% of carbon monoxide and hydrogen, as well as CH₄, CO₂, H₂O, HCl, HF, COS, NH₃, HCN, and H₂S (based on the sulfur content of the feedstock). This resultant gas may be termed dirty syngas. The gasifier 16 may also generate waste, such as slag 18, which may be a wet ash material. This slag 18 may be removed from the gasifier 16 and disposed of, for example, as road base or as another building material.

The dirty syngas from the gasifier 16 may then be cleaned in a syngas cleaning system 20. For example, the syngas cleaning system 20 may scrub the cooled dirty (e.g., non-scrubbed) syngas to remove the HCl, HF, COS, HCN, and H₂S from the cooled dirty (e.g., non-scrubbed) syngas, which may include separation of sulfur 22 by, for example, an acid gas removal (AGR) process. Furthermore, the syngas cleaning system 20 may separate salts 24 from the cooled dirty (e.g., non-scrubbed) syngas via a water treatment process that may utilize water purification techniques to generate usable salts 24 from the cooled dirty (e.g., non-scrubbed) syngas. Subsequently, the gas from the syngas cleaning system 20 may include clean (e.g., scrubbed) syngas. In certain embodiments, a gas processor 26 may be utilized to remove residual gas components 28 from the clean (e.g., scrubbed) syngas such as, ammonia, methanol, or any residual chemicals. However, removal of residual gas components 28 from the clean (e.g., scrubbed) syngas is optional, since the clean (e.g., scrubbed) syngas may be utilized as a fuel even when containing the residual gas components 28, e.g., tail gas.

In addition, in certain embodiments, a carbon capture system 30 may remove and process the carbonous gas (e.g., carbon dioxide that is approximately 80-100 percent pure by volume) contained in the syngas. The carbon capture system 30 also may include a compressor, a purifier, a pipeline that supplies CO₂ for sequestration or enhanced oil recovery, a CO₂ storage tank, or any combination thereof. The scrubbed syngas, which has undergone the removal of its sulfur containing components and a large fraction of its carbon dioxide, may be then transmitted to a combustor 32, e.g., a combustion chamber, of a gas turbine engine 34 as combustible fuel. As described in greater detail below, the scrubbed syngas delivered to the combustor 32 may contain higher percentages of hydrogen than syngas generated by IGCC plants that do not use carbon capture techniques.

The IGCC plant 10 may further include an air separation unit (ASU) 36. The ASU 36 may operate to separate air into component gases by, for example, distillation techniques. The ASU 36 may separate oxygen from the air supplied to it from an ASU compressor 38, and the ASU 36 may transfer the separated oxygen to the gasifier 16. Additionally, the ASU 36 may transmit separated nitrogen to a diluent gaseous nitrogen (DGAN) compressor 40. As described below, the ASU compressor 38 may include one or more compression sections, one or more inter-coolers between the compression sections, and/or one or more after-coolers after the compression sections. The inter-coolers and after-coolers may cool the compressed air before delivering the compressed air to the ASU 36.

The DGAN compressor 40 may compress the nitrogen received from the ASU 36 at least to pressure levels equal to those in the combustor 32 of the gas turbine engine 34, for proper injection to happen into the combustor chamber. Thus, once the DGAN compressor 40 has adequately compressed the nitrogen to a proper level, the DGAN compressor 40 may transmit the compressed nitrogen to the combustor 32 of the gas turbine engine 34. The nitrogen may be used as a diluent to facilitate control of emissions, for example.

The gas turbine engine 34 may include a turbine 42, a drive shaft 44 and a compressor 46, as well as the combustor 32. The combustor 32 may receive fuel, such as syngas, which may be injected under pressure from fuel nozzles. This fuel may be mixed with compressed air as well as compressed nitrogen from the DGAN compressor 40, and combusted within combustor 32. This combustion may create hot pressurized combustion gases.

The combustor 32 may direct the combustion gases towards an inlet of the turbine 42. As the combustion gases from the combustor 32 pass through the turbine 42, the combustion gases may force turbine blades in the turbine 42 to rotate the drive shaft 44 along an axis of the gas turbine engine 34. As illustrated, drive shaft 44 is connected to various components of the gas turbine engine 34, including the compressor 46.

The drive shaft 44 may connect the turbine 42 to the compressor 46 to form a rotor. The compressor 46 may include blades coupled to the drive shaft 44. Thus, rotation of turbine blades in the turbine 42 causes the drive shaft 44 connecting the turbine 42 to the compressor 46 to rotate blades within the compressor 46. This rotation of blades in the compressor 46 may cause the compressor 46 to compress air received via an air intake in the compressor 46. The compressed air may then be fed to the combustor 32 and mixed with fuel and compressed nitrogen to allow for higher efficiency combustion. The drive shaft 44 may also be connected to a first load 48, which may be a stationary load, such as an electrical generator for producing electrical power, for example, in a power plant. Indeed, the first load 48 may be any suitable device that is powered by the rotational output of the gas turbine engine 34.

The IGCC plant 10 also may include a steam turbine engine 50 and a heat recovery steam generation (HRSG) system 52. The steam turbine engine 50 may drive a second load 54. The second load 54 may also be an electrical generator for generating electrical power. However, both the first and second loads 48, 54 may be other types of loads capable of being driven by the gas turbine engine 34 and steam turbine engine 50, respectively. In addition, although the gas turbine engine 34 and steam turbine engine 50 may drive separate loads 48 and 54, as shown in the illustrated embodiment, the gas turbine engine 34 and steam turbine engine 50 may also be utilized in tandem to drive a single load via a single shaft. The specific configuration of the steam turbine engine 50, as well as the gas turbine engine 34, may be implementation-specific and may include any combination of sections.

The IGCC plant 10 may also include the HRSG 52. Heated exhaust gas from the gas turbine engine 34 may be transported into the HRSG 52 and used to heat water and produce steam used to power the steam turbine engine 50. Exhaust from, for example, a low-pressure section of the steam turbine engine 50 may be directed into a condenser 56. The condenser 56 may utilize a cooling tower 58 to exchange heated water for cooled water. The cooling tower 58 acts to provide cool water to the condenser 56 to aid in condensing the steam transmitted to the condenser 56 from the steam turbine engine 50. Condensate from the condenser 56 may, in turn, be directed into the HRSG 52. Again, exhaust from the gas turbine engine 34 may also be directed into the HRSG 52 to heat the water from the condenser 56 and produce steam.

In combined cycle systems such as the IGCC plant 10, hot exhaust may flow from the gas turbine engine 34 and pass to the HRSG 52, where it may be used to generate high-pressure, high-temperature steam. The steam produced by the HRSG 52 may then be passed through the steam turbine engine 50 for power generation. In addition, the produced steam may also be supplied to any other processes where steam may be used, such as to the gasifier 16. The gas turbine engine 34 generation cycle is often referred to as the “topping cycle,” whereas the steam turbine engine 50 generation cycle is often referred to as the “bottoming cycle.” By combining these two cycles as illustrated in FIG. 1, the IGCC plant 10 may lead to greater efficiencies in both cycles. In particular, exhaust heat from the topping cycle may be captured and used to generate steam for use in the bottoming cycle.

IGCC plants which utilize carbon capture techniques, such as the carbon capture system 30 illustrated in FIG. 1, operate somewhat differently than typical IGCC plants. For example, the scrubbed syngas delivered to the combustor 32 of the gas turbine engine 34 may be referred to as “high-hydrogen” syngas. In other words, the scrubbed syngas combusted in the combustor 32 may, in certain embodiments, consist of greater than approximately two-thirds H₂ by volume, as opposed to lower percentages of H₂ in non-carbon capture IGCC plants. More specifically, the term “high-hydrogen” may relate to syngas with a ratio of H₂/CO of approximately greater than 2. The reason for the higher percentage of H₂ in the scrubbed syngas is that, as described above, the carbon capture system 30 may remove much of the carbonous gases from the scrubbed syngas upstream of the combustor 32. As such, the relative percentage of carbon components in the scrubbed syngas is reduced, thereby increasing the relative percentage of hydrogen components.

The high-hydrogen syngas delivered to the combustor 32 may cause the gas turbine engine 34 to experience a certain degree of derating. In other words, since there are higher amounts of hydrogen and, therefore, lower amounts of carbon in the high-hydrogen syngas, the gas turbine engine 34 may not be capable of generating the same amount of power as with typical fuels, such as methane and other natural gases. More specifically, the higher concentrations of H₂ in the scrubbed syngas may cause the firing temperature of the combustor 32 to deviate from the design firing temperature of the combustor 32, thereby changing the combustion characteristics within the combustor 32. A similar type of derating occurs at IGCC plants located at higher elevations, where the percentage of oxygen in the air received by the compressor 46 of the gas turbine engine 34 is decreased, thereby again increasing the relative percentages of H₂ combusted in the combustor 32, with respect to carbon and oxygen.

In each case (e.g., high-hydrogen syngas and high-elevation locations), the amount of deration may fall within a range of approximately 5-20%. For example, in certain embodiments, using high-hydrogen syngas in the combustor 32 may lead to deration of the gas turbine engine 34 of 5%, 6%, 7%, 8%, 9%, 10%, 11%, 12%, 13%, 14%, 15%, 16%, 17%, 18%, 19%, 20%, or even more. Similarly, assuming the IGCC plant 10 is located at an elevation of 1500-2000 feet, an expected deration of the gas turbine engine 34 may be at least approximately 10% or greater. As the elevation increases, the amount of deration of the gas turbine engine 34 also increases.

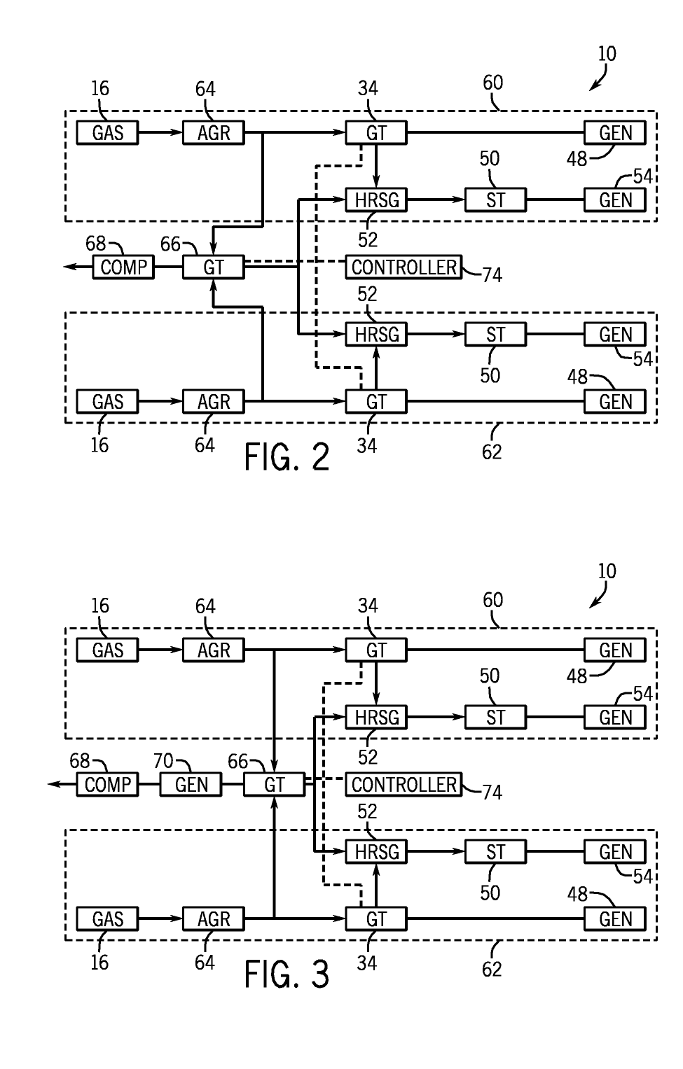

Although illustrated in FIG. 1 as including only one gasifier 16, one syngas cleaning system 20, one gas turbine engine 34, one steam turbine engine 50, and one HRSG 52, in certain embodiments, the IGCC plant 10 may include more than one of each of these components. More specifically, in certain embodiments, the IGCC plant 10 may include multiple IGCC systems, each including a gasifier 16, a syngas cleaning system 20, a gas turbine engine 34, a steam turbine engine 50, an HRSG 52, and so forth. For example, FIG. 2 is a schematic diagram of the IGCC plant 10 having first and second IGCC systems 60, 62. As illustrated, both the first and second IGCC systems 60, 62 include a gasifier 16, an AGR process 64, a gas turbine engine 34, a first generator 48 driven by the gas turbine engine 34, an HRSG 52, a steam turbine engine 50, and a second generator 54 driven by the steam turbine engine 50. As described above, the AGR process 64 may be part of the syngas cleaning system 20 of FIG. 1. Although illustrated as having two IGCC systems 60, 62, in certain embodiments, the IGCC plant 10 may include three, four, five, six, or more IGCC systems.

In certain embodiments, each of the main gas turbine engines 34 may be capable of generating between approximately 150 megawatts (MW) and 250 MW of power for use by an external power grid. For example, in certain embodiments, each main gas turbine engine 34 may generate 150 MW, 160 MW, 170 MW, 180 MW, 190 MW, 200 MW, 210 MW, 220 MW, 230 MW, 240 MW, 250 MW, or even more. As such, in certain embodiments, the combination of the main gas turbine engines 34 of the first and second IGCC systems 60, 62 may generate 300 MW, 320 MW, 340 MW, 360 MW, 380 MW, 400 MW, 420 MW, 440 MW, 460 MW, 480 MW, 500 MW, or even more. Therefore, the total deration of the combination of the main gas turbine engine 34 of the first and second IGCC systems 60, 62 may fall within a range of approximately 30 MW and 50 MW. For example, in certain embodiments, the total deration of the combination of the main gas turbine engine 34 of the first and second IGCC systems 60, 62 may be 30 MW, 35 MW, 40 MW, 45 MW, 50 MW, or more.

As illustrated, in certain embodiments, the IGCC plant 10 may also include a supplemental gas turbine engine 66 to account for the deration of the main gas turbine engines 34. The supplemental gas turbine engine 66 may be configured to receive high-hydrogen syngas downstream of the AGR processes 64 of the first and second IGCC systems 60, 62 and to burn the high-hydrogen syngas to generate power for auxiliary loads of the IGCC plant 10. As such, the supplemental gas turbine engine 66 may be capable of supplementing the total deration of the main gas turbine engines 34 of the first and second IGCC systems 60, 62. For example, in certain embodiments, the supplemental gas turbine 66 may be capable of generating between approximately 30 megawatts and 60 MW of power. For example, in certain embodiments, the supplemental gas turbine engine 66 may generate 30 MW, 35 MW, 40 MW, 45 MW, 50 MW, 55 MW, 60 MW, or more.

As used herein, the term “main load” refers to the first and second loads 48, 54 driven by the main gas turbine engines 34 and the main steam turbine engines 50, respectively. These main loads 48, 54 may, in certain embodiments, be generators that generate electrical power, the main output of the IGCC plant 10. Conversely, as used herein, the term “auxiliary load” refers to loads that are internal to the IGCC plant 10. In certain embodiments, the supplemental gas turbine engine 66 may be dedicated to only driving auxiliary loads of the IGCC plant 10, rather than main loads of the IGCC plant 10. In other words, the supplemental gas turbine engine 66 may only support other processes of the IGCC plant 10, rather than generating electricity for an external power grid. However, in other embodiments, the supplemental gas turbine engine 66 may be used to make up for the loss of power (e.g., from deration) of the main gas turbine engines 34 of the IGCC plant 10 to maintain a desired range of total power output of the IGCC plant 10.

FIGS. 2-5 illustrate different types of auxiliary loads that may be driven by the supplemental gas turbine engine 66. For example, as illustrated in FIG. 2, in certain embodiments, the supplemental gas turbine engine 66 may drive a compressor 68 of the carbon capture system 30 of FIG. 1. More specifically, the compressor 68 may be configured to compress CO₂ captured by the carbon capture system 30. In addition, as illustrated in FIG. 3, in other embodiments, the supplemental gas turbine engine 66 may drive a third generator 70 (e.g., a supplemental generator), which may drive the compressor 68 for compressing the CO₂ captured by the carbon capture system 30. However, the third generator 70 illustrated in FIG. 3 as being driven by the supplemental gas turbine engine 66 may also be configured to power other auxiliary loads throughout the IGCC plant 10.

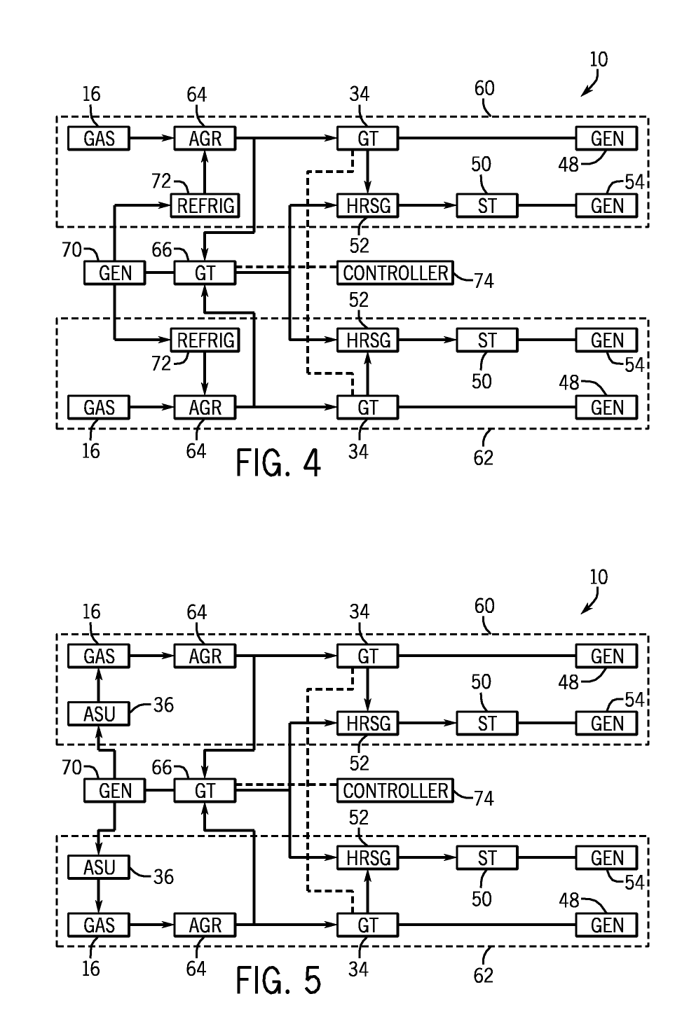

For example, as illustrated in FIG. 4, in certain embodiments, the third generator 70 driven by the supplemental gas turbine engine 66 may be configured to supply power to refrigeration systems 72 associated with the AGR process 64 of the syngas cleaning system 20. In certain embodiments, the AGR process 64 may include an absorber, which may receive dirty (e.g., non-scrubbed) syngas from the gasifier 16 of FIG. 1 and clean the dirty (e.g., non-scrubbed) syngas to generate clean (e.g., scrubbed) syngas. More specifically, the absorber of the AGR process 64 may use a solvent to purify (e.g., remove acid gas from) the dirty (e.g., non-scrubbed) gas stream. The solvent may be introduced through the top of the absorber. As the solvent moves downward through the absorber, the solvent may selectively absorb acid gas vapor from the dirty (e.g., non-scrubbed) syngas, such that clean (e.g., scrubbed) syngas exits near the upper portion of the absorber. As such, a mixture of the solvent and acid gas may exit through the bottom of the absorber.

The solvent/acid gas mixture may be directed into a solvent regenerator. Since the acid gas is generally lighter than the solvent, the acid gas may generally exit through the top of the solvent regenerator whereas the solvent exits through the bottom of the solvent regenerator. The solvent exiting through the bottom of the solvent regenerator may be at a higher temperature than the solvent/acid gas mixture that enters the solvent regenerator. However, the solvent may generally absorb the acid gas vapor within the absorber most effectively when the solvent is at lower temperatures. As such, the AGR process 64 may include the refrigeration systems 72 to cool the solvent before the solvent enters through the top of the absorber. Cooling the solvent enhances its ability to remove acid gas in the absorber.

In certain embodiments, the refrigeration systems 72 may include vapor absorption refrigeration (VAR) cycles, each including an absorber containing an absorbent within which a refrigerant may dissolve, a pump for increasing the pressure and temperature of the absorbent/refrigerant mixture, a condenser for cooling the refrigerant while maintaining the higher pressure of the refrigerant, an expansion valve for reducing the pressure and temperature of the refrigerant to create a gaseous/liquid state of the refrigerant, and an evaporator for cooling the solvent. The generator 70 may, in certain embodiments, drive the pumps of the VAR cycles. Conversely, in other embodiments, the refrigeration systems 72 may include vapor compression refrigeration (VCR) cycles, each including a compressor for compressing a refrigerant to create a superheated refrigerant at higher pressures and temperatures, a condenser for cooling the superheated refrigerant while maintaining the higher pressure of the refrigerant, an expansion valve for reducing the pressure and temperature of the refrigerant to create a gaseous/liquid state of the refrigerant, and an evaporator for cooling the solvent. The generator 70 may, in certain embodiments, drive the compressors of the VCR cycles. Using the supplemental gas turbine engine 66 to drive the refrigeration systems 72 may prove particularly beneficial because solvent requirements increase when utilizing the carbon capture system 30 of FIG. 1.

In addition, as illustrated in FIG. 5, in certain embodiments, the third generator 70 driven by the supplemental gas turbine engine 66 may be configured to supply power to the ASU 36 of FIG. 1. More specifically, the third generator 70 may provide power for the ASU compressor 38 associated with the ASU 36. As described above, the ASU compressor 38 may compress air, which may be delivered to the ASU 36, where oxygen, nitrogen, and other component gases may be separated from the compressed air. For example, oxygen separated from the compressed air may be directed into the gasifier 16 of FIG. 1 and nitrogen separated from the compressed air may be directed into the DGAN compressor 40 of FIG. 1. Using the supplemental gas turbine engine 66 to drive the ASU compressor 38 may prove particularly beneficial because, in general, more oxygen is needed when utilizing the carbon capture system 30 of FIG. 1.

As illustrated in FIGS. 2-5, in certain embodiments, the supplemental gas turbine engine 66 may also be associated with a controller 74, which may be configured to control operating parameters of the supplemental gas turbine engine 66. In addition, in certain embodiments, the controller 74 may be configured to control operating parameters of the main gas turbine engines 34 of the first and second IGCC systems 60, 62 as well. More specifically, the controller 74 may be configured to vary operating parameters (e.g., speed, fuel flow, air flow, and so forth) of the supplemental gas turbine engine 66 and the main gas turbine engines 34 based on requirements of the main gas turbine engines 34. For example, depending on the amount of hydrogen in the scrubbed syngas delivered to the main gas turbine engines 34, the degree of deration of the main gas turbine engines 34 may vary over time. Therefore, in certain embodiments, the controller 74 may be configured to vary operating parameters of both the supplemental gas turbine engine 66 and the main gas turbine engines 34 based on varying hydrogen compositions of the scrubbed syngas.

Furthermore, in other embodiments, the controller 74 may be configured to vary operating parameters of the supplemental gas turbine engine 66 and the main gas turbine engines 34 based on varying loads (e.g., main and auxiliary loads) that use power from the supplemental gas turbine engine 66 and/or the main gas turbine engines 34. For example, in certain embodiments, both the supplemental gas turbine engine 66 and the main gas turbine engines 34 may be used to provide power to a particular auxiliary load (e.g., dedicated to an auxiliary load). As the auxiliary load varies over time, operating parameters of the supplemental gas turbine engine 66 and/or the main gas turbine engines 34 may be varied to account for both variations of the auxiliary load as well as variations in the deration of the main gas turbine engines 34 (e.g., due to variations in the hydrogen percentage of the scrubbed syngas). In addition, in other embodiments, the amount of carbon capture performed by the carbon capture system 30 of FIG. 1 may be varied based on the amount of deration of the main gas turbine engines 34. For example, in certain embodiments, if the deration of the main gas turbine engines 34 reaches a predetermined amount, the amount of carbon capture may be temporarily reduced.

The controller 74 may, in certain embodiments, be a physical computing device uniquely programmed to control valves, pumps, compressors, turbines, and so forth. More specifically, the controller 74 may include input/output (I/O) devices for determining how to control the control valves, pumps, compressors, turbines, and so forth. In addition, in certain embodiments, the controller 74 may also include storage media for storing historical data, theoretical performance curves, and so forth.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
an integrated gasification combined cycle (IGCC) system, comprising:
a gasifier configured to convert a feedstock into syngas;
a syngas cleaning system configured to clean the syngas to scrub scrubbed syngas;
a carbon capture system configured to remove carbonous gases from the scrubbed syngas to create high-hydrogen syngas;
a main gas turbine engine configured to burn the high-hydrogen syngas to generate power for a first primary load of the IGCC system;
a heat recovery steam generation (HRSG) system configured to receive heated exhaust gas from the main gas turbine engine and to generate steam using the heated exhaust gas as a source of heat; and
a steam turbine engine configured to receive the steam from the HRSG system and to use the steam to generate power for a second primary load of the IGCC system; and
a supplemental gas turbine engine configured to burn the high-hydrogen syngas to generate power for an auxiliary load of the IGCC system.

2. The system of claim 1, wherein the auxiliary load comprises a captured carbon compressor configured to compress the carbonous gases removed by the carbon capture system.

3. The system of claim 1, wherein the auxiliary load comprises an electrical generator configured to drive a captured carbon compressor.

4. The system of claim 1, wherein the auxiliary load comprises an electrical generator configured to drive a refrigeration system of the syngas cleaning system.

5. The system of claim 1, wherein the auxiliary load comprises an electrical generator configured to drive an air separation unit (ASU) compressor.

6. The system of claim 1, wherein the high-hydrogen syngas comprises at least two-thirds hydrogen by volume.

7. The system of claim 1, wherein the supplemental gas turbine engine is configured to generate power only for an auxiliary load of the IGCC system.

8. The system of claim 1, comprising a second IGCC system, wherein the supplemental gas turbine engine is configured to generate power for an auxiliary load of the second IGCC system.

9. A carbon capture integrated gasification combined cycle (IGCC) system, comprising a supplemental gas turbine engine configured to burn a high-hydrogen syngas to generate power only for an auxiliary load.

10. The system of claim 9, comprising a carbon capture system having the auxiliary load.

11. The system of claim 10, wherein the auxiliary load comprises a captured carbon compressor configured to compress carbonous gases removed by the carbon capture system.

12. The system of claim 10, wherein the auxiliary load comprises an electrical generator configured to drive a compressor to compress carbonous gases removed by the carbon capture system.

13. The system of claim 9, comprising a syngas cleaning system having the auxiliary load, wherein the auxiliary load comprises a refrigeration system.

14. The system of claim 9, comprising an air separation unit (ASU) compressor, wherein the auxiliary load comprises an electrical generator configured to drive the ASU compressor.

15. The system of claim 9, wherein the high-hydrogen syngas comprises at least two-thirds hydrogen by volume.

16. A system, comprising:
a carbon capture gasification combined cycle (IGCC) system having a main gas turbine engine configured to generate power for a primary load and a supplemental gas turbine engine configured to generate power only for an auxiliary load; and
a gas turbine engine controller configured to vary operating parameters of the main gas turbine engine and the supplemental gas turbine engine.

17. The system of claim 16, wherein the carbon capture IGCC system comprises a carbon capture system having the auxiliary load, and the auxiliary load comprises a captured carbon compressor configured to compress carbon dioxide removed by the carbon capture system.

18. The system of claim 16, wherein the carbon capture IGCC system comprises a carbon capture system having the auxiliary load, and the auxiliary load comprises an electrical generator configured to drive a compressor to compress carbonous gases removed by the carbon capture system.

19. The system of claim 16, wherein the carbon capture IGCC system comprises a syngas cleaning system having a refrigeration system, and the auxiliary load comprises an electrical generator configured to drive the refrigeration system of the syngas cleaning system.

20. The system of claim 16, wherein the carbon capture IGCC system comprises an air separation unit (ASU) compressor, and the auxiliary load comprises an electrical generator configured to drive the ASU compressor.
